(19) United States
(12) Patent Application Publication
(10) Pub. No.: US 2005/0102203 A1
(43) Pub. Date: May 12, 2005

(54) Order-handling inventory management system and method

(76) Inventor: Koh Soo Keong, Singapore (SG)

Correspondence Address: LADAS & PARRY, 5670 WILSHIRE BOULEVARD, SUITE 2100, LOS ANGELES, CA, 90036-5679, US

(21) Appl. No.: 10/362,816

(22) PCT Filed: Aug. 21, 2001
(86) PCT No.: PCT/SG01/00164

(30) Foreign Application Priority Data
Aug. 21, 2000 (SG) 200004726-6

(51) Int. Cl. G06F 17/60; G06F 7/00

(52) U.S. Cl. 705/28; 700/216; 340/572.1; 340/5.92

(57) ABSTRACT

An order-handling inventory management system includes a database that is capable of containing information about the products. This information includes availability and location of the products when these products are stored in a warehouse. A radio frequency subsystem uses radio frequencies to detect identificators that are on the products stored in the storage site. An order-receiving-processing subsystem receives orders for products and ascertains from the database the availability and the location of the products in the storage site. A handheld RF scanner, which is part of the radio frequency subsystem, is used to detect the products within the storage site by detecting the identification of the products.

### FIELD OF INVENTION

The invention relates to an order-handling inventory management system, and a method of handling orders.

### PRIOR ART

The advent of electronic commerce over the internet initially promised a lowest way of doing business where customers provide sales orders via the internet E-commerce promised new levels of profits because traditional functions, such as advertising, catalogues, receiving of orders and payments, could be handled electronically via the internet.

However, it has been found that the processing of the sales orders is an area that adds costs to the operation due to inefficiencies of time. For instance, in known warehouse storage systems, time is wasted in locating the whereabouts of products in the warehouse, because of the need to visually inspect the products. Moreover, time is taken up in physical handling the products from the time of bringing the products out of storage through to shipping. Time is also wasted due to the need to manually enter data into the order processing system.

The time wastage problems have been partially solved by the use of barcode readers which are used to scan the products. However, barcodes require a line of sight for the readers to work, which means that the product, bearing the barcode, has to be in full view for the barcode reader to work. Thus, the use of barcodes does not avoid the need to search for items within a warehouse by having to physically handle the product and to open storage boxes to find the products. Moreover, more time is required to conduct stock takes because of the need to visually locate the products in order to use the barcode reader. Occasionally, errors in the database may result in the actual products picked from the storage site not being the items ordered by the customer. Barcodes are also dependent on printouts for checking the status of the inventory, which may result in human errors when reading the printouts. Another problem is that, although barcodes are relatively cheap to produce, barcodes can be photocopied and duplicated easily.

Another problem of e-commerce is the cost of handling and shipping. Often, the high shipping costs negate the lower costs of the actual products offered for sale by internet. Sometimes, orders consisting of a few books are delivered in boxes that are far larger than necessary. The extra costs for shipping or posting the unnecessarily large box add to the overall purchase cost, and decreases the profit margins of the business.

Alternatively, when human judgment is used to select the appropriate sized box for an order, inappropriate choice can be made which wastes time to repack the products into the correct box.

It is an object of the present invention to overcome or at least ameliorate at least one of the problems in the prior art, or to provide an alternative to the prior art.

### SUMMARY OF INVENTION

According to an aspect of the present invention, there is provided an order-handling inventory management system for products, including
a database capable of containing information about the products including availability and location of the products;
a radio frequency subsystem operatively adapted to detect radio-frequency-detectable identificators that are attachable to the products stored in one or more storage sites, the products forming at least part of an inventory; and
an order-receiving-processing subsystem for receiving orders for products and ascertaining from the database the availability and the location of the products in the one or more storage sites, which uses the radio frequency subsystem to detect the actual products within the storage site or sites by detecting the identificators of the ordered products;
wherein the order-receiving-processing subsystem uses the radio frequency subsystem to detect products contained within a package to be shipped to verify that the contents of the package correspond to a received order.

Preferably, packages for containing the products are provided with a radio-frequency-readable package identificator that contains information on the order. Advantageously the radio-frequency-readable package identificator includes information on the contents of a package.

In preferred embodiments, the order may be verified by comparing information contained in the package identificator with the identificators attached to the product or products in the package.

The order-receiving-processing subsystem may generate a mailing label and/or a packing list for mailing an order and, ideally, the mailing label and/or a packing list and/or a packing list is generated only after the contents of the: package have been verified and matched with the order.

According to another aspect of the present invention, there is provided an order-handling inventory management system for products including:
a database capable of containing information about the products including availability and location of the products, and physical aspects of the products, including one or more of length, width, thickness, volume or weight;
a radio frequency subsystem operatively adapted to detect radio-frequency-detectable identificators that are attachable to the products stored in one or more storage sites, the products forming at least part of an inventory; and
an order-receiving-processing subsystem for receiving orders for products and ascertaining from the database the availability and the location of the products in the one or more storage sites, which uses the radio frequency subsystem to detect the actual products within the storage site or sites by detecting the identificators of the ordered products.

Preferably, the database includes information on packages for the products including volumes and physical dimensions of one or more packages. The order-receiving-processing subsystem may be operatively adapted to select a minimum-sized package capable of containing the product or products based on the information on the physical aspects of each product or products in the order.

Ideally, the selection of the minimum-sized package enables the order-receiving processing subsystem to calculate a minimum delivery cost required to deliver the package to the customer.

The order-receiving-processing subsystem is preferably connectable to the Internet to provide on-line customers with interactive information concerning the minimum delivery cost.

The order-receiving-processing subsystem may be adapted to electronically receive orders, and ideally receives the orders via the Internet by the user entering order information into a web-page.

Preferably, the database further includes information stored on each of the identificators.

The order-handling inventory management system may include one or more sorting stations and a number of bays, wherein a product is assigned a bay at the or each sorting station together with an appropriately sized package for packaging at the assigned bay.

In a preferred embodiment, the radio frequency subsystem includes a portable radio frequency reading device that indicates the location of a product in the storage site by detecting the identificator thereof. The portable reading device may accumulate information for a plurality of products, and preferably is able to upload information from the database which is operatively connectable to the portable reading device via a transmitting means. Advantageously, when a product is removed from its storage location, the portable reading device is updated to reflect the product as having been picked. Preferably, the portable reading device downloads to the database information on the products that have been picked via a transmission means.

The products managed by the order-handling inventory management system may be books or printed material. Alternatively, the products may be any one or more of computer parts and components, software, vehicle spare parts, medical products and prescription drugs, video tapes and compact discs.

Information on expiry dates of the products may be storable in the database and/or on the identificators to identify and locate products that have passed their expiry dates.

In a further aspect of the present invention there, is: provided a method of handling an order for a product from an inventory, including the steps of:
using an order-receiving-processing subsystem to receive an order for a product;
obtaining information concerning availability and location of the product from a database containing information about the product;
providing the information concerning location of the product to a radio frequency subsystem;
using the radio frequency subsystem to detect a radio-frequency-detectable identificator that is attached to the product stored in one or more storage sites, the product forming part of the inventory;
verifying that a product contained within a package to be shipped corresponds to the received order by using the radio frequency subsystem to detect a radio-frequency-detectable identificator that is attached to the product contained within the package to be shipped.

Preferably, the method further includes the step of providing the package to be shipped with a radio-frequency-readable package identificator that contains information on the order. Advantageously, the radio-frequency-readable package identificator includes information on the contents of the package. The verifying step may include comparing information contained in the package identificator with the identificator attached to the product contained within the package.

In one embodiment the method further includes the step of generating a mailing label and/or a packing list and/or a packing list for mailing an order. It is preferable that the mailing label and/or a packing list and/or a packing list is generated only after the contents of the package have been verified and matched with the order.

In yet another aspect, the present invention provides a method of handling an order for a product from an inventory, including the steps of:
using an order-receiving-processing subsystem to receive an order for a product;
obtaining information concerning availability and location of the product, and physical aspects of the product, including one or more of length, width, thickness, volume or weight from a database containing information about the product;
providing the information concerning location of the product to a radio frequency subsystem;
using the radio frequency subsystem to detect a radio-frequency-detectable identificator that is attached to the product stored in one or more storage sites, the product forming part of the inventory.

Preferably, the database includes information on packages for the products including volumes and physical dimensions of one or more packages.

Advantageously, the method further includes the step of selecting a minimum-sized package capable of containing the product. The selecting step may include calculating a minimum delivery cost requited to deliver the package to the customer. Preferably, on-line customers, connected via the Internet, are provided with interactive information concerning the minimum delivery cost.

### DRAWINGS

In order that the invention might be more filly understood, embodiments of the invention are described, by way of example only, with reference to the accompanying drawings, in which:

FIG. 1 illustrates a schematic diagram of a storage site that uses an embodiment of an order-handling inventory management system to handle orders for products stored in the warehouse;

FIG. 2 shows the screen of the handheld radio frequency reader which shows the whereabouts of a particular book in the warehouse;

FIG. 3 is a sample screen of the uploading and downloading terminal where the handheld radio frequency (“RF”) reader uploads and downloads information between the database;

FIG. 4 is a sample screen of a computer monitor at the sorting station of FIG. 1;

FIG. 5 is a sample screen of a computer monitor at the verification station of FIG. 1;

FIG. 6 is an example of a radio frequency box tag, the radio frequency component of the tag being hidden behind the front panel of the box tag;

FIGS. 7A to 7D provide an example of a single continuous flow-chart which describes an embodiment of an order-handling inventory management. The information described in and ascertainable from the flow-chart is included in the disclosure of exemplary embodiments of the present invention; and

FIG. 8 is a block diagram of the embodiment of the order-handling inventory management system of FIG. 1.

### DESCRIPTION OF EMBODIMENTS

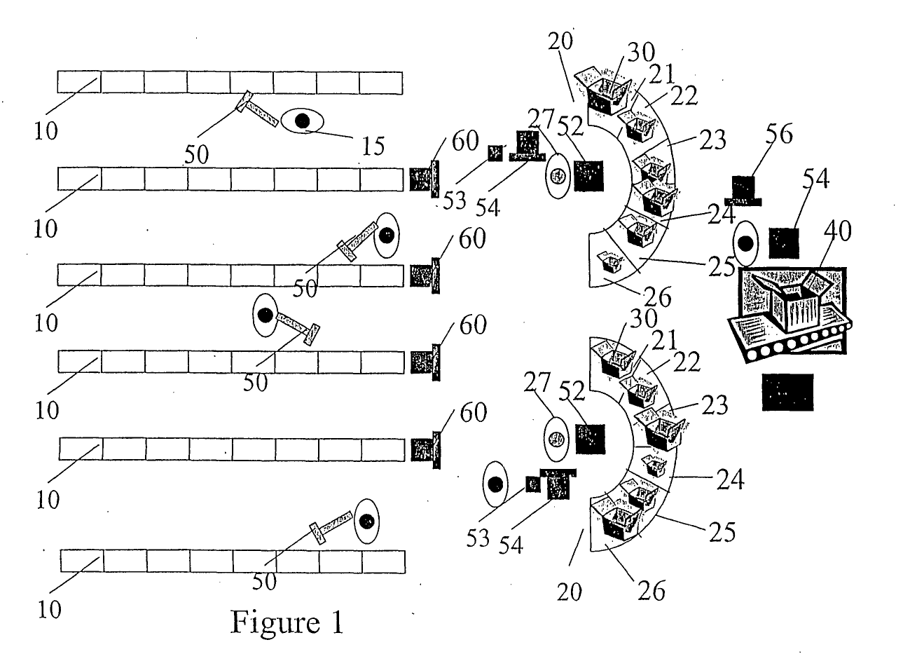

Referring to the drawings, FIG. 1 illustrates a schematic diagram of an exemplary embodiment of an order-handling inventory management system used at a storage site or warehouse. The management system may also adapted for a business where the products are stored in one or more storage sites.

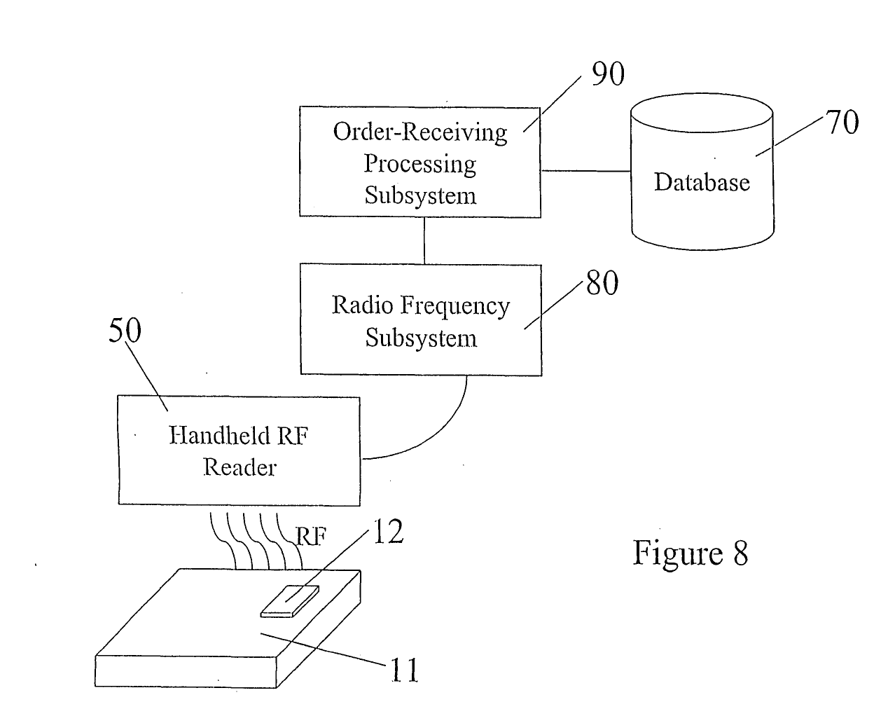

A block diagram of the order-handling inventory management system is shown in FIG. 8.

The example of the inventory management system is described with reference to a book-selling business. The business has a warehouse that contains a large number of books forming at least part of the total inventory of tie business, but the inventory also includes out of stock books that can be ordered. The total business inventory may be in one warehouse, or spread over a number of warehouses in various parts of a country.

In FIG. 1, books 11 are stored on shelves, pallets or storage racks 10. In these shelves 10, the books (not shown in FIG. 1) may be stored in boxes with the books being hidden from view. When a customer submits an order for certain books, the task at the warehouse is to locate the books in the storage site, and to bring the books to sorting stations 20 where the books are packed in boxes for shipping.

Preferably, titles of the same book are kept in the same area in the shelves 10, but in other embodiments, books of the same title may be scattered throughout the warehouse. The use of radio frequency (“RF”) tracking and detection enables copies of books to be located easily, regardless of where they are stored.

Each sorting station 20 has a number of bays 21, 22, 23, 24, 25, 26, one bay being allocated for each customer order. At this bay, the books of the order are assembled and packed each into a box 30.

After the box 30 has been packed, the box is taken to a verification station 40 where the box is checked to see that the correct books are in the bon A postage address label also is affixed to the box.

It will now be described how the use of the exemplary inventory management system, using radio frequency devices, has made this overall process more efficient.

Identificators

Each book in the warehouse is provided with an identificator 12. When the inventory is spread over a number of warehouses, all the books are provided with identificators.

In the embodiment, all copies of a particular book title each have their own unique identification number stored in the identificator. In other words, ten copies of the same book require the use of ten different identification numbers.

In the embodiment, the identificators are radio frequency identification tags 50, as seen in FIG. 1. The tags includes a miniature antenna and an EPROM for containing information about the books, such as the identification number, the book details, and the location of the book in the warehouse. All this is stored in the EPROM memory that is readable by radio frequency. The tags are passive in tie sense that they have no power source. One EPROM have the capacity to be “programmed” in the sense that radio frequency waves can be used to change the information contained in the EPROM of the tags. When the tags receive radio frequency waves emitted from the radio frequency subsystem, the tag becomes “energized” and emits radio waves that carry the information stored in the EPROM.

Such radio frequency identification tags are provided on the books (“RF book tags”) and on the shipping boxes used to ship the books to the customer (“RF box tags”), which will be described later.

Database

The inventory management system includes a database 70 capable of containing information about all the books. The database, which resides on a computer server, need not be located on the same site as the warehouses, but maybe connected by network to the various storage sites around the country or, indeed, in different countries.

Radio Frequency Subsystem

The inventory management system also includes a radio frequency subsystem 80 which is able to detect the identificators on the various products in one or more storage sites. The invention is not limited to a particular configuration of such a radio frequency subsystem, since skilled engineers can create a number of modifications which can detect the identificators on each of the books by means of radio frequency detection technology.

The radio frequency subsystem includes a number of components that use radio frequency technology to transfer information between the database and an order-receiving-processing subsystem.

The radio frequency subsystem includes a handheld RF reader 50, the RF readers 52 at the sorting stations 20, and the RF reader 54 at the verification station 40.

Order-Receiving-Processing Subsystem

The inventory management system includes an order-receiving-processsing subsystems 90 which receives orders from customers.

The order-receiving-processing subsystem, upon receiving an order, checks with the inventory management system to check the availability of the ordered books in the inventory. If available, the system will instruct details of the customer's order to be uploaded into the handheld reader station 60, where the details will be uploaded to the handheld reader 50. The information that is to be passed from the database to the handheld RF reader will include details of the whereabouts of the books in the warehouse.

For a nationwide warehousing system, which are found in large e-commerce companies, the inventory management system can extend across the different warehouses in different states or countries. The inventory management system can check the availability and location of a book in any one of the warehouses. For instance, warehouses are in California, Texas and New York, the inventory management system can identify which warehouse has a particular book title, and also where the book is to be found in the warehouse, even down to the shelf location. This is possible because each book has an identificator that is detectable by the radio frequency subsystem.

The identificator of each book, even books of the same title, has a unique identification number stored in its EPROM. This unique identity number is used for tacking and tracing the book, and for financial accounting purposes. When a customer's order is placed, the unique identity number stipulates which book is to be assigned to fulfill the customer's order.

Database

The inventory management system has an inventory database. When the order-receiving-processing subsystem receives an order from a customer, it checks with the database whether the particular book is in stock and the whereabouts of a copy of the requested title.

The order-receiving-processing subsystem is connected to the database in order to access information in the database.

In the embodiment, the order-receiving-processing subsystem electronically receives orders from customers, for instance, by internet.

The database 70 includes information that is stored on each identificator tag 12. The data of the tag forms an integral part of the database. As seen in FIG. 8, the radio frequency subsystem enables the database and the order-receiving-processing subsystem to access the information contained in the identificator tags.

The database is stored in a computer and includes the following data:—
i) A picture catalog of the front cover of the book;
ii) Dimensions of each book, including volume and weight;
iii) Part number directly corresponding to the title of the book;
iv) Part number directly corresponding to the unique identification numerb stored on the RF identificator tag;
v) Pallet location or bin location where the book is stored.

The database contains data relating to physical aspects of the books. In particular, the length, width, thickness, volume and/or weight of each book. Hence, if a particular book is available in more than one edition, each edition is considered as a separate item on the database inventory, since each edition has different physical aspects.

Using the physical information of each book, the order-receiving-processing subsystem calculates the total volume and weight of the customer's order. For example, if a customer orders five books, the order-receiving-processing subsystem calculates the total length, width and height of the books of the customer's order (when stacked), and can ascertain the volume and weight of the total order. This calculation enable the system to match the order with a minimum-sized package that is necessary to contain the order. This avoids a situation where unnecessarily large packages are used to ship squall amounts of product. This minimises shipping costs so that profit margins of the business can be increased.

The database also contains information on physical aspects of a number of packages/boxes, such as volume, length, width and height of the various boxes. Thus, the order-receiving-processing subsystem matches the minimum package required to enclose the order of books. Thus, the present embodiment avoids a wasteful practice found in prior art business systems where orders for small numbers of books or products are shipped in boxes that are larger than necessary. The present embodiment selects a minimum sized package so that shipping and postage costs can be minimized.

In the prior art, e-commerce and mail order businesses often have a fixed shipping fees for particular order price ran-es. The use of standard shipping fees can increase the cost to such an extent that there is no longer any cost advantage when buying products over the internet. For instance, in the prior art, if one book were to be ordered, the standard shipping fee is often a large percentage of the total order. Therefore, in the present embodiment, the ability to obtain a shipping cost that is the absolute minimum necessary will enable the shipping costs to be determined on a case-by-case basis, taking into account the physical dimensions and weight of the total order.

When embodiments of the invention are connected to the internet, information of the minimum delivery cost can be provided to on-line customers in real time. When a customer orders products via a website, the customer indicates which books are to be ordered. The inventory management system uses the information in the database to ascertain the location and availability of the particular titles ordered. Details of the physical dimensions and weight of the products are obtained from the database. The order-receiving-processing subsystem calculates the minimum package and shipping costs. This minimum shipping cost is transmitted on-line to the web page for the customer to view in real time. In other words, e-commerce customers need not pay a standard shipping fee, but can be provided with information concerning the absolute minimum shipping cost of the order at the time of placing their order.

Order Processing

An example will be described of the steps involved with the order-handling inventory management system. In this embodiment, the order handling inventory management system is able to be accessed by customers either electronically or via the internet. In the case of the internet, the customer transmits the order for particular books by entering ordering information into a web page.

The book order is received by a web server or directly through a network server by electronic data exchange. The internet order is transferred to the network server through a firewall.

When the order is first received, a credit check is performed on the customer's credit card number, either by the order-receiving-handling subsystem, or externally.

The order-receiving-subsystem checks the database to see if the ordered books are in stock in the warehouse. This is achieved by attempting to match the book's part number with a corresponding number in the database. If the book is not in stock, a message is sent to the customer by e-mail asking for consent to partially fulfill the order.

An order number, unique to the particular customer order, is generated. The order number is linked to the customer's name, delivery address and the ordered items. All this is stored in the database. The order number traces the books, for tracking and accounting purposes, and hence must be unique.

The order-receiving-processing subsystem assigns one of the bays 20-26 to the order number.

Collecting the Products from Storage

Referring to FIG. 1, a collection workman 15 is assigned to collect the books from storage. The workman searches for books for a particular sorting station, and retrieves books for all the bays in that sorting station. To assist the workman with this task, the radio frequency subsystem includes a product-locating-apparatus that is adapted to provide the workman with information concerning the whereabouts of each ordered book.

The product-locating apparatus includes the handheld radio frequency scanner 50. The handheld scanner 50 is able to detect and read the identificators 12 on the books 11. An RF antenna of the handheld reader 50 continually emits radio fluency waves. The identificator 12 on a book gives a response when it comes within the reading range of the handheld scanner. At any given moment, the antenna of the handheld scanner 50 may be receiving numerous responses, but will only pick out the response of the book 11, or the identity of the book that it is searching for. Identificators are read and processed one at a time by the handheld RF reader 50 (although, to the user, this appears to happen simultaneously), although the identificators are responding to the handheld reader all at the same time. The RF reader 50 does not simultaneously process all the identities that it receives.

The collection workman 15 uses the handheld scanner 50 to “upload” information from the database 70. The information from the database is transmitted to the handheld scanner by radio frequency transmission. This happens at the handheld reader station 60 where the scanner 50 is allowed to communicate with the database 70 via a radio frequency terminal 60. A number of such terminals or reader stations 60 are located throughout the warehouse, to make it convenient for the workman 15 to upload order information into the handheld scanner 50 from the database via the nearest station 60. The transfer of information between the handheld scanner and the database can occur by cable connection or remote connection such as by infra Red connections.

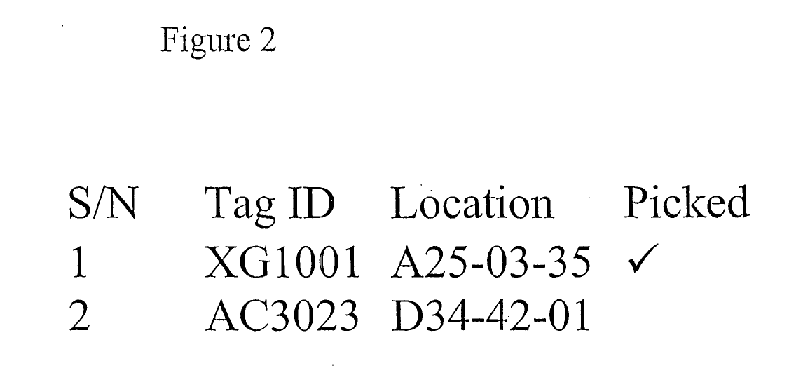

Thus, the handheld scanner receives uploaded information, obtained from the database, that tells the workman of the whereabouts of the book(s) for each order. An example of the information on the handheld scanner's 50 screen is shown in FIG. 2. The book's identification (TAG ID) is shown, together with its whereabouts in the warehouse. With this information, the worker walks directly to the correct shelf to collect the book.

When the collector workman reaches a particular pallet or shelf location, the workman passes the reader 50 over and around the boxes, and immediately identifies the items of interest. If the identification contained in the EPROM of the book tag 12 matches the data in the handheld reader 50, the reader beeps to indicate that the particular book is in that box. This avoids the workman having to open the box to search for the book. It also avoids the worker having to visually inspect the products for the expiry date. Instead, the handheld reader 50 enables the worker to go directly to the location of the book box and pick out the item from its container.

Upon the first book being identified on the shelf, the information in the scanner 50 is automatically modified to indicate that the first book has now been “picked”, as in FIG. 2. In other embodiments, this modification of the scanner's information may require the workman to key in the modification.

The information in the handheld scanner can include the books of a number of customer orders. This is more efficient than having the collector worker 15 go into the warehouse for each customer order.

The system automatically consolidates orders at hourly intervals or at any predetermined interval. The data for the consolidated orders is downloaded to the handheld scanner 50. To maximise the use of the scanner's memory, only the unique identification numbers of the required books are downloaded into the handheld reader, so that it can ‘pick’ out the book.

Post-Collection Updating of the Database

As the collector worker collects the books from the warehouse, he alters the data in the handheld RF scanner 50 to indicate which books have been “picked”. The information in the handheld scanner is thus becoming more up-to-date than the database information concerning the whereabouts of the books. Hence, after all the books have been collected, in order to synchronize the information, the worker takes the handheld scanner 50 and “downloads” the information into the database, so that the database has a record that these books have now been removed from the warehouse shelves.

This synchronization avoids a situation where the database might indicate that a certain book is in stock, when in fact that book has been removed from the warehouse.

The downloading of the data to the database occurs in the same manner as the information on books to be collected was initially uploaded from the database.

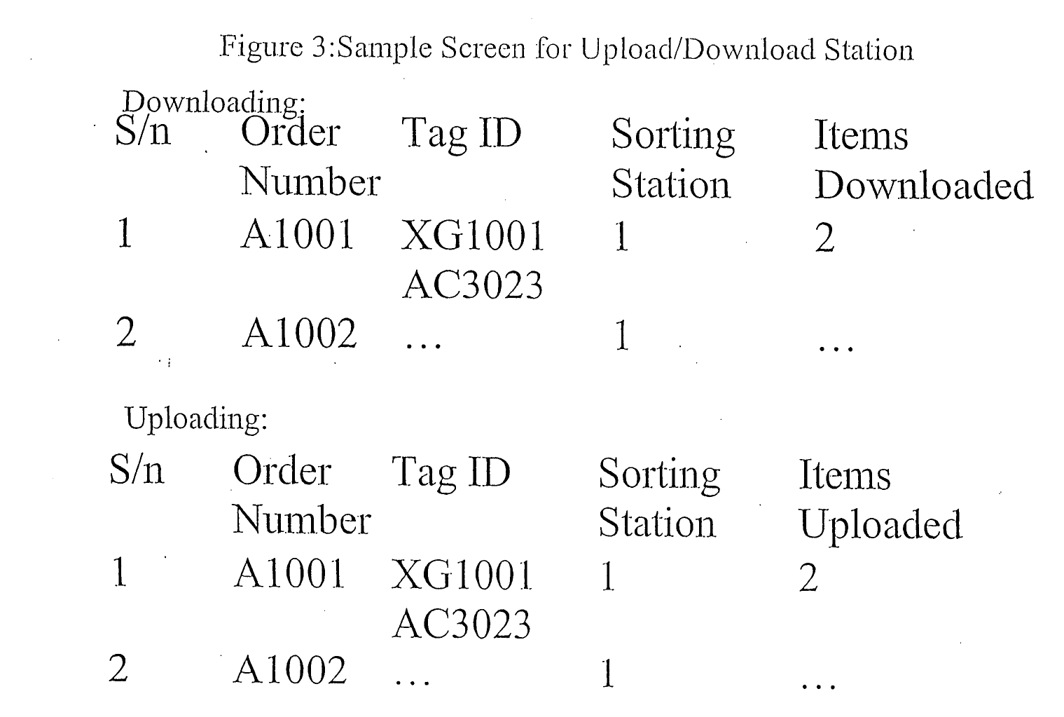

FIG. 3 is a sample screen of the uploading and downloading terminal where the handheld RF reader uploads and downloads information between the database. The screen shows two different modes, one during uploading and the other during downloading. The screen tells the workman the order number(s) that has been downloaded, the tag identification number, and the sorting station 20 that the books are to be taken to, as well as the number of items downloaded into his reader. The information is similar in respect of the downloading. The purpose of the information is to tell the database that the items have been collected from the warehouse and are ready for sorting.

After the information has been synchronised, the information that the books have been collected causes the sorting station 20 to initiate the sorting process.

Calculation of Appropriate Box Size

While the collector worker 15 is collecting the books from the warehouse, the system provides the worker 27 at the sorting station with instructions on what sized box to use. For a given book order, the order-receiving-processing subsystem draws from the database information about the physical size of the ordered book(s). The total volume of the ordered books is calculated. The order-receiving-processing subsystem queries the database for dimensional data on the range of available boxes, and assigns the minimum-sized box that is necessary to ship the order.

Each of the box sizes have a code, and the order-receiving-processing indicates the box to be used by displaying the box's code.

The order-receiving-processing subsystem displays on the terminal 54 which bay number the box is for. (Each bay is used to receive the books of a particular order number). The sorting worker 27 obtains the required box size, and also uses the box tag generator 53 to create a box tag to be attached to the box. A tag is created in the sense that the EPROM is programmed with information from the order-receiving-processing subsystem particularly the order number, and the printable portion of the tag is printed with pertinent information.

Sorting

The collector worker then brings all the collected books (which are for a number of orders) to the sorting station 20.

The box tag generator 53 is located at the sorting station 20. When the sorting station 20 receives books to be sorted, the tag generator 53 prints a box to. The box tag, having the order number printed thereon together with an RF identificator, is affixed to the box that has been selected. The system instructs the worker as to which sized-box should be placed at each bay.

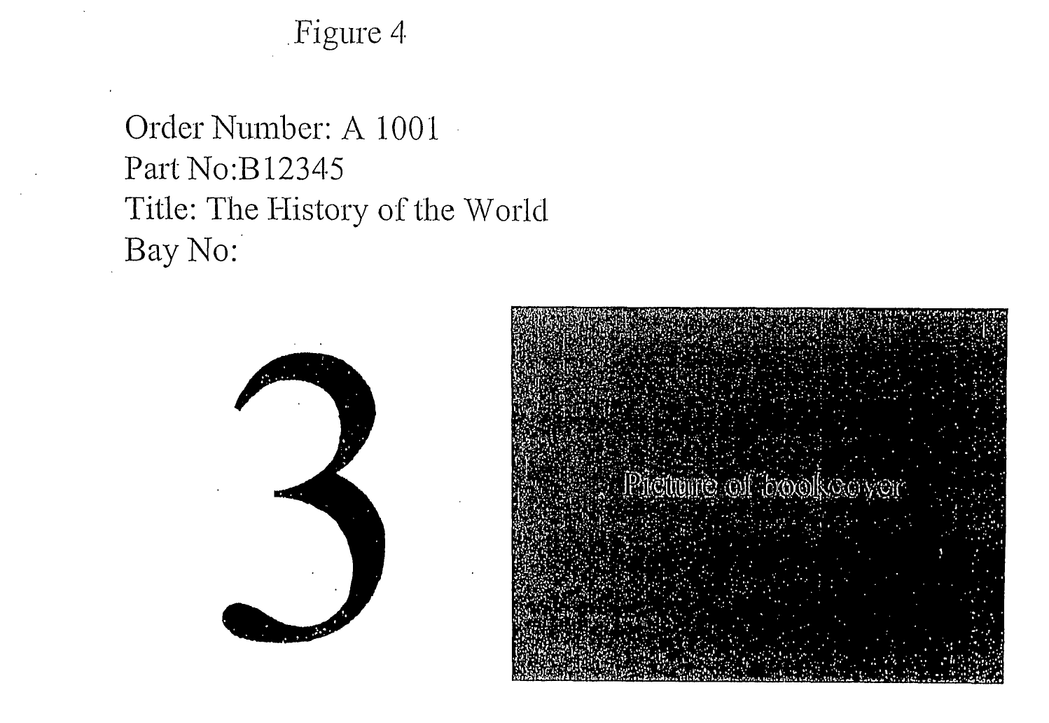

At the sorting station, each book is read by an RB reader 52. The RB reader 52 detects the RF book tags 12, and ascertains from the order-receiving-processing subsystem which in bay each book is to be placed. As the worker passes each book near the RF reader 52, the order-receiving-processing subsystem, which is in communication with the database, displays on the monitor 54 the bay number that the worker is to place the book. An example of the display is shown in FIG. 4. A picture of the book cover is also displayed on the monitor screen 54, so that the worker can ensue that the right book has been selected. Hence, the workman 27 places the book in bay number three 23. The workman passes all the books past the RF reader 52 and, thus is directed to allocate each of the books to the appropriate bays 21-26.

Packing the Products into the Boxes

While one of the workmen 15 is collecting the books from the shelves, he may be picking books that are for a number of different customer orders, not just one order. All the books from different orders may be mixed. For instance, the workman might collect three copies of a particular title, each copy being for a different customer order. (Each copy has a different identification). The order-receiving-processing subsystem provides the worker with information on the whereabouts of the books.

At the same time, the order-receiving-processing is also performing another task, which is to provide information to the sorting station 20 about what books are to go to which bay 21-26, as seen in FIG. 1.

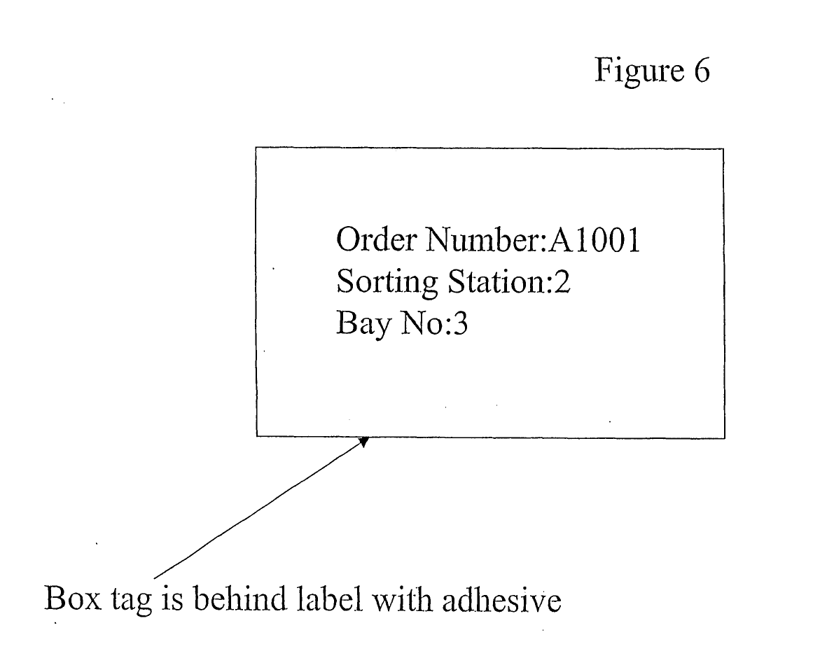

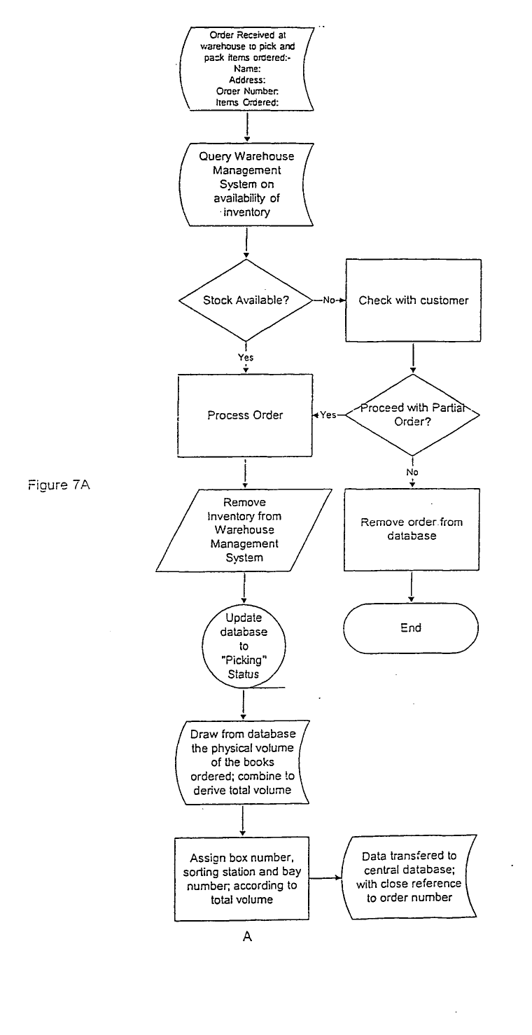

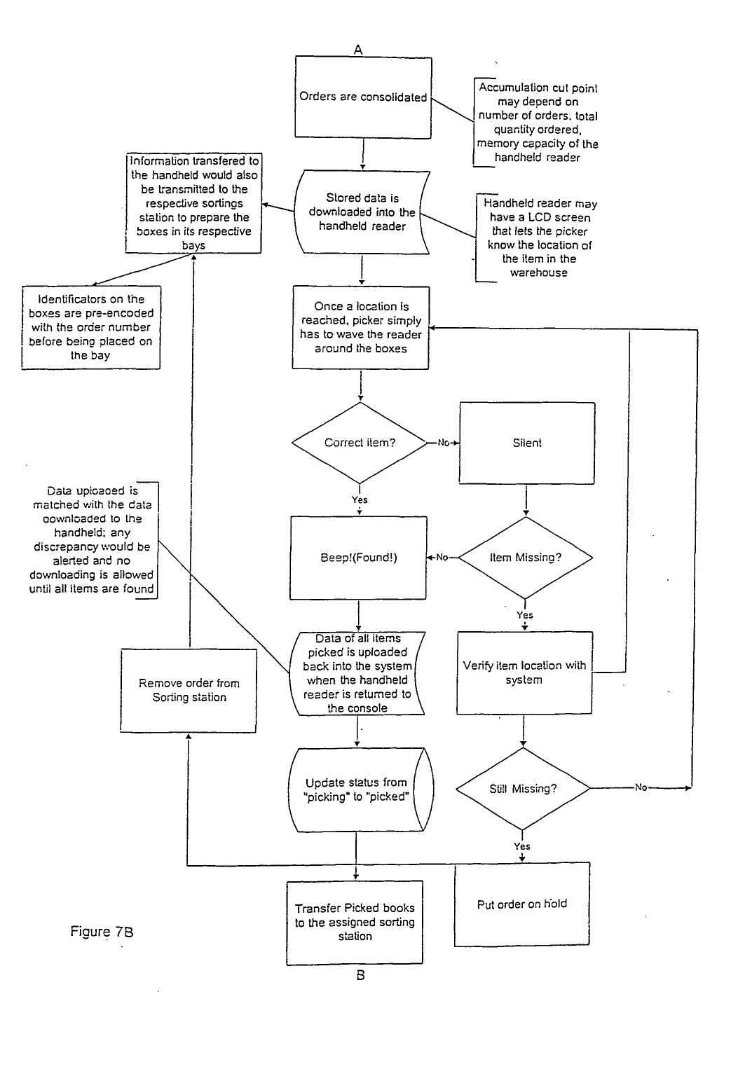

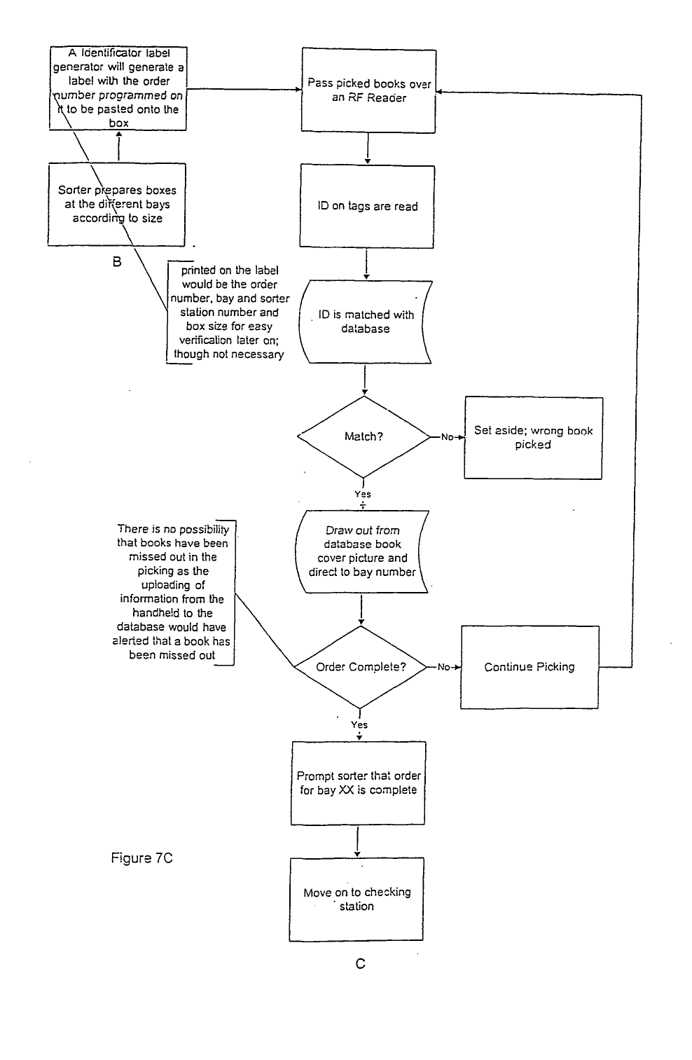

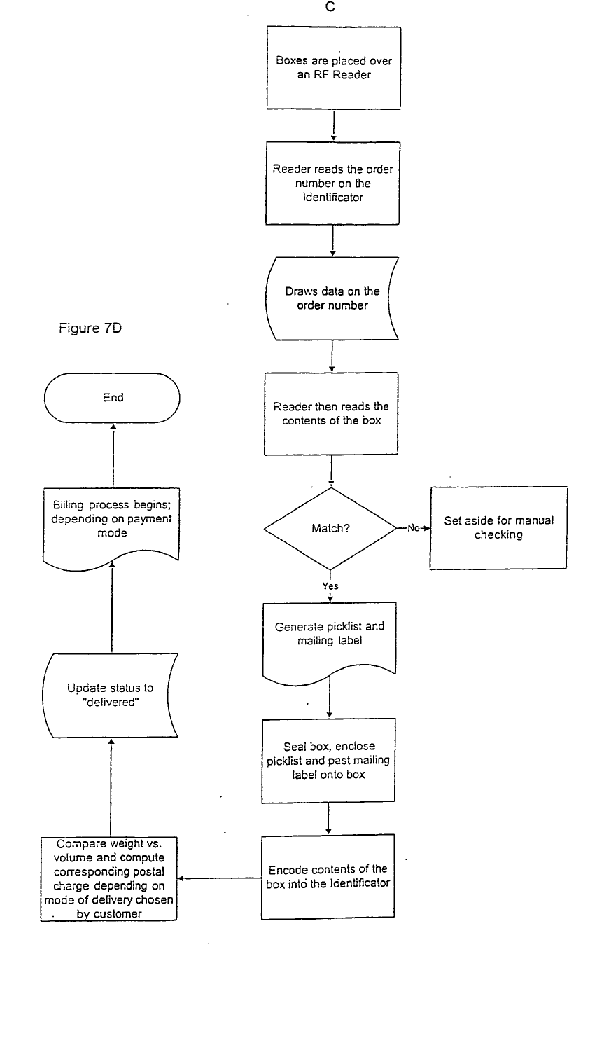

A RF tag generator 53, which is part of the radio frequency subsystem, is used to generate a RF box tag. In other words, the RF reader 52 at the sorting station programs the EPROM in the RF box tag, and records the information of the books that ought to comprise the order. This RF box tag is affixed to the box, and acts as a record of what books should actually be in the box. FIG. 6 illustrates an example of a RF box tag which has a radio frequency detectable component, as well as a printed surface for displaying information visually. It is in the form of an adhesive label, with printed information on one side, and the RF component on the underside. The RF tag is almost paper thin and is flexible.

After the box has been filled with the complete order, the system prompts the sorter 27 that the box is complete and ready to be moved on to the verification station 40.

Verification of Order Prior to Shipping

After the box has been filled with the appropriate books, the box is taken to the verification station 40. There, another RF reader 54 first reads the box tag to ascertain the order number. Then, it draws from the database the details of the books of this order. It then reads the book tags inside the box. By reading both the book tags as well as the box tag, it can be checked whether the contents in the box matches the contents of the order. Thus, by comparing the EPROM information contained in the book tags with the order information in the database, it is possible to verify that the box contains all the required books.

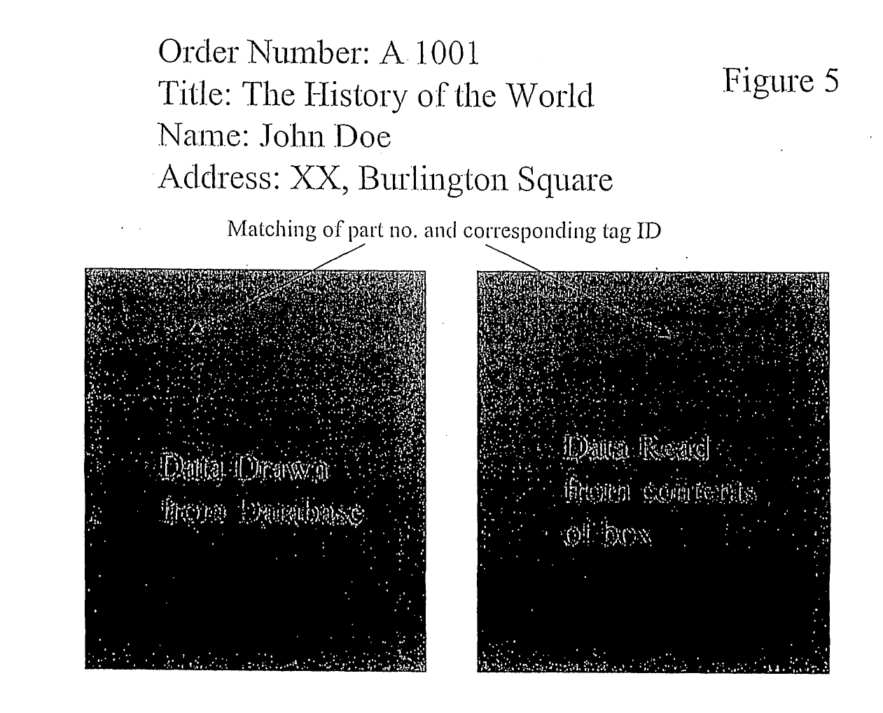

FIG. 5 shows a sample screen which appears on the monitor at the verification station 40. On the top of the screen 56, details of the order number are shown. On the left hand side of the screen 56, details are drawn from the box tag showing the required order of books (which were obtained from the database). On the right hand side of the screen, details are drawn from the book tags 12 inside the box. Thus, a side by side visual comparison can be made to cheek that the required books are in the box, although the comparison occurs electronically.

After verifying the contents, a packing list bearing the order number is printed which lists the items contained in the box. This automatically prompts the generation of a mailing label with postal data drawn from the database. The mailing label is pasted onto the box. The packing list is placed in the box and sealed.

In embodiments, the reference can be read directly from the database via an RF reader. In further embodiments, the data in the box tag may be used as the reference for what should be in the box. In such cases, once the box is sealed, the data of the contents of the box would be then stored into the box tag identificator on the exterior of the box.

Based on the weight and dimensions of the order, the order-receiving-processing subsystem calculates the postage or courier charges. Using the information of volume and weight, the system is able to calculate the charges, depending on whether express, surface or courier service is required.

At the verification station 40, the status of each book in the database is updated to the status of “delivered” and the books are removed from the inventory management system. This assists in keeping financial accounts of the warehouse, because storage charges are incurred up until the point when the book is physically removed from the warehouse.

An RF reader can be used, at any point in the shipping process, can be used to check the contents of the box.

The ability to identify products using radio frequency, without the need for a line of sight, is an advantage because it reduces the amount of physical handling of products. Products can be identified by scanning without having to open the boxes.

The ability to read a particular identificators in multiples at a time reduced the search time.

The processes of the embodiments can be a paperless processes, and the only document that needs to be printed is the packing list that is sent to the customer who cannot read the RF identificators.

The embodiments of the invention have been described in terms of books, but the system is applicable to other products particularly those that are popularly sold over the internet, for example computer parts and components, software, vehicle spare parts, medical products and prescription drugs, video tapes and CD's, to name a few.

The information on the database need not be physically restricted to one location. For instance, certain parts of the information can be stored in the identificators rather th on the mass storage of the overall system.

In the illustrated embodiments, a collection worker 15 walks around the warehouse to collect the books. In alternative embodiments, an Automated Storage and Retrieval System (A.S.R.S.) may be linked to the order-handling inventory management system. This means that rather than a worker collecting the books from a particular pallet, that particular pallet is automatically brought to the worker, for example, by mechanical cranes or an appropriate automated system.

Other embodiments of the present invention are able to be adapted to conducting stock takes of the inventory of a warehouse. Rather than collecting information on specific books, the handheld scanner gathering information on all the books in the warehouse. The stock take is conducted by comparing gathered information with the database information.

Embodiments of the system can be used for quickly crating inventory lists. Missing items in the warehouse can be located readily using embodiments of the invention.

Modifications of the invention can be used to control inventory levels having regard to the shelf life of products. The information on expiry dates can be stored in the main server of the database. When the expiry dates draw near, the system can prompt the expiry date data to be uploaded into the handheld RF reader, which enables the workers to locate the products that are soon to expire. Out of date items can be readily located. This is useful for pharmaceuticals and first aid kits where medicines have a limited expiry date.

Alternatively, in other embodiments, the expiry date information may reside in the identificators themselves. The inventory management system would obtain information from the tags that related to when the products will expiring without needing to obtain the containers.

The storage site may be a fulfillment centre for telemarketing, e-commerce purchases, or where components are assembled as kits of parts.

The identificator tags can be tags that simply emit radio frequency, or can be tags that transmit as well as receive radio frequency.

The embodiments have been advanced by way of example only, and modifications are possible within the scope of the invention as defined by the appended claims.

1. An order-handling inventory management system for products, including:
a database capable of containing information about the products including availability and location of the products;
a radio frequency subsystem operatively adapted to detect radio-frequency-detectable identificators that are attachable to the products stored in one or more storage sites, the products forming at least part of an inventory; and
an order-receiving-processing subsystem for receiving orders for products and ascertaining from the database the availability and the location of the products in the one or more storage sites, which uses the radio frequency subsystem to detect the actual products within the storage site or sites by detecting the identificators of the ordered products;
wherein the order-receiving-processing subsystem uses the radio frequency subsystem to detect products contained within a package to be shipped to verify that the contents of the package correspond to a received order.

2. A system according to claim 1 wherein packages for containing the products are provided with a radio-frequency-readable package identificator that contains information on the order.

3. A system according to claim 2 wherein the radio-frequency-readable package identificator includes information on the contents of a package.

4. A system according to claim 2 or 3 wherein the order can be verified by comparing information contained in the package identificator with the identificators attached to the product or products in the package.

5. A system according to any one of the preceding claims wherein the order-receiving-processing subsystem generates a mailing label and/or a packing list for mailing an order.

6. A system according to claim 5 wherein the mailing label and/or a packing list is generated only after the contents of the package have been verified and matched with the order.

7. An order-handling inventory management system for products, including:
a database capable of containing information about the products including availability and location of the products, and physical aspects of the products, including one or more of length, width, thickness, volume or weight;
a radio frequency subsystem operatively adapted to detect radio-frequency-detectable identificators that are attachable to the products stored in one or more storage sites, the products forming at least part of an inventory; and
an order-receiving-processing subsystem for receiving orders for products and ascertaining from the database the availability and the location of the products in the one or more storage sites, which uses the radio frequency subsystem to detect the actual products within the storage site or sites by detecting the identificators of the ordered products.

8. A system according to claim 7 wherein the database includes information on packages for the products including volumes and physical dimensions of one or more packages.

9. A system according to claim 7 or 8 wherein, based on the information on the physical aspects of each product or products in the order, the order-receiving-processing subsystem is operatively adapted to select a minimum-sized package capable of containing the product or products.

10. A system according to claim 9 wherein the selection of the minimum-sized package enables the order-receiving-processing subsystem to calculate a minimum delivery cost required to deliver the package to the customer.

11. A system according to claim 10 wherein the order-receiving-processing subsystem is connectable to the Internet to provide on-line customers with interactive information concerning the minimum delivery cost.

12. A system according to any one of the preceding claims wherein the order-receiving-processing subsystem is adapted to electronically receive orders.

13. A system according to claim 12 wherein the order-receiving-processing subsystem receives the orders via the Internet by the user entering order information into a web-page.

14. A system according to any one of the preceding claims wherein the database further includes any information stored on each of the identificators.

15. A system according to any one of the preceding claims including one or more sorting stations and a number of bays, wherein a product is assigned a bay at the or each sorting station together with an appropriately sized package for packaging at the assigned bay.

16. A system according to any one of the preceding claims wherein the radio frequency subsystem includes a portable radio frequency reading device that indicates the location of a product in the storage site by detecting the identificator thereof.

17. A system according to claim 16 wherein the portable reading device accumulates information for a plurality of products.

18. A system according to claim 16 or 17 wherein the portable reading device uploads information from the database which is operatively connectable to the portable reading device via a transmitting means.

19. A system according to any one of claims 16 to 18 wherein when a product is removed from its storage location, the portable reading device is updated to reflect the product as having been picked.

20. A system according to claim 19 wherein the portable reading device downloads to the database information on the products that have been picked via a transmission means.

21. A system according to any one of the preceding claims wherein the products are books or printed material.

22. A system according to any one of the preceding claims wherein the products are any one or more of computer parts and components, software, vehicle spare parts, medical products and prescription drugs, video tapes and compact discs.

23. A system according to any one of the preceding claims wherein information on expiry dates of the products are storable in the database and/or on the identificators to identify and locate products that have passed their expiry dates.

24. A method of handling an order for a product from an inventory, including the steps of:
using an order-receiving-processing subsystem to receive an order for a product;
obtaining information concerning availability and location of the product from a database containing information about the product;
providing the information concerning location of the product to a radio frequency subsystem;
using the radio frequency subsystem to detect a radio-frequency-detectable identificator that is attached to the product stored in one or more storage sites, the product forming part of the inventory;
verifying that a product contained within a package to be shipped corresponds to the received order by using the radio frequency subsystem to detect a radio-frequency-detectable identificator that is attached to the product contained within the package to be shipped.

25. A method according to claim 24, further including the step of providing the package to be shipped with a radio-frequency-readable package identificator that contains information on the order.

26. A method according to claim 25 wherein the radio-frequency-readable package identificator includes information on the contents of the package.

27. A method according to claim 25 or 26 wherein the verifying step includes comparing information contained in the package identificator with the identificator attached to the product contained within the package.

28. A method according to any one of claims 24-27 further including the step of generating a mailing label and/or a packing list for mailing an order.

29. A method according to claim 28 wherein the mailing label and/or a packing list is generated only after the contents of the package have been verified and matched with the order.

30. A method of handling an order for a product from an inventory, including the steps of:
using an order-receiving-processing subsystem to receive an order for a product;
obtaining information concerning availability and location of the product, and physical aspects of the product, including one or more of length, width, thickness, volume or weight from a database containing information about the product;
providing the information concerning location of the product to a radio frequency subsystem;
using the radio frequency subsystem to detect a radio-frequency-detectable identificator that is attached to the product stored in one or more storage sites, the product forming part of the inventory.

31. A method according to claim 30 wherein the database includes information on packages for the products including volumes and physical dimensions of one or more packages.

32. A method according to claim 30 or 31 further including the step of selecting a minimum-sized package capable of containing the product.

33. A method according to claim 32 wherein the selecting step includes calculating a minimum delivery cost required to deliver the package to the customer.

34. A method according to claim 33 wherein the selecting step includes providing on-line customers, connected via the Internet, with interactive information concerning the minimum delivery cost.
